(19) United States
(12) Patent Application Publication
(10) Pub. No.: US 2015/0025964 A1
(43) Pub. Date: Jan. 22, 2015

(54) SYSTEM AND METHOD FOR DEMONSTRATING A SOFTWARE APPLICATION

(71) Applicant: RainingClouds Technologies Private Limited, Balewadi Phata (IN)

(72) Inventor: Aniket Maruti AWATI, Sangliwadi (IN)

(21) Appl. No.: 13/945,077

(22) Filed: Jul. 18, 2013

(51) Int. Cl. G06Q 30/02

(52) U.S. Cl. CPC G06Q 30/0251
USPC 705/14.49

(57) ABSTRACT

A method and system for demonstrating a software application to a user is provided. The system comprises an application management platform that communicates with an electronic device of the user over a communication network. The application management platform provides an advertisement notification to the user via the electronic device. On performing an action on the advertisement notification by the user, a connection is established between the electronic device and the application management platform. The application management platform streams audiovisual content of the software application to the electronic device and captures user inputs from the electronic device. The user inputs comprise motions performed by the user on the streamed audiovisual content. The application management platform thereby provides the demonstration of a full version of the software application to the user.

### FIELD OF INVENTION

The method and system disclosed herein, in general, relates to managing a software application. More particularly, the method and system disclosed herein relates to demonstration of the software application to a user.

### BACKGROUND OF THE INVENTION

Product promotion is an indispensable part of any trade or business. The primary objectives of such promotions include providing information about a product to potential customers, increasing customer's demand for the product, etc. Traditional promotional methods are based on passive advertising, wherein a business entity advertises its product in the general media such as newspapers, radio, television commercials, etc. However, passive advertising is mostly ineffective in acquiring a significant number of customers. Furthermore, with drastic and ever-increasing growth in competition and consumer-awareness, business entities were required to develop active and innovative methods of advertisements to help their products stand out in the market, which led to the adoption of interactive advertising.

The term “interactive advertisement” refers to a form of active advertising where a business enterprise puts forth its product in the market for customers to experience and assess the product firsthand. The assessment of the product by the customers helps the business entity understand the preferences, requirements and expectations of the customers as regards the product and accordingly improve the product to suit the customers' needs.

Presently, business entities use different types of interactive advertisement methods including providing product demonstrations. The product demonstrations are in the form of, for example, video demonstrations, demonstrations using a prototype or product trials, comparative advertising, etc. Business entities that sell software products often demonstrate their products by providing product trials that allow the potential customers to assess a software product.

Conventional methods of providing the software product for trials to potential customers include providing a limited version of the software for trial. The limitations would be in terms of the number of trials of the software itself or in terms of the duration for using the software or both. However, such limited versions of the software provided for trial often fails to provide a complete picture of the scope of the software. Therefore, there is a need for providing a complete version of the software for trial.

Currently, trial versions of software applications are required to be downloaded and installed by a potential consumer onto his/her personal electronic device for such trials. Despite providing a full-version trial, the business entities have not been able to obtain a higher customer conversion rate. Hard-disk space constraints, among other things, discourage potential customers from trying out the software which therefore defeats the purpose of such demonstrations. As a consequence, the probability of acquiring higher customer conversion rate is adversely affected.

Hence, there exists a need for a method and system for demonstrating a full version of a software application on an electronic device of a user, without the user having to install or download the software application on the user's electronic device.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

A method and system for demonstrating a software application to a user is provided. An application management platform that communicates with an electronic device of the user over a communication network is provided. The application management platform provides an advertisement notification to the user via the electronic device. In an embodiment, the application management platform provides the advertisement notification to the user by embedding the software application in a third party application program on the user's electronic device. In another embodiment, the application management platform provides the advertisement notification to the user through a third party webpage.

On performing an action on the advertisement notification by the user, a connection is established between the electronic device and the application management platform. The actions performed by the user on the advertisement notification comprises, for example, clicking the advertisement notification by the user. The application management platform streams audiovisual content of the software application to the electronic device and captures user inputs from the electronic device. The user inputs comprise motions performed by the user on the streamed audiovisual content. The application management platform thereby provides the demonstration of a full version of the software application to the user.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 exemplarily illustrates a system for demonstrating a software application to a user.

FIG. 2 illustrates a method for demonstrating a software application to a user.

FIG. 3 exemplarily illustrates architecture of a computer system employed by an application management platform for demonstrating the software application to the user.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

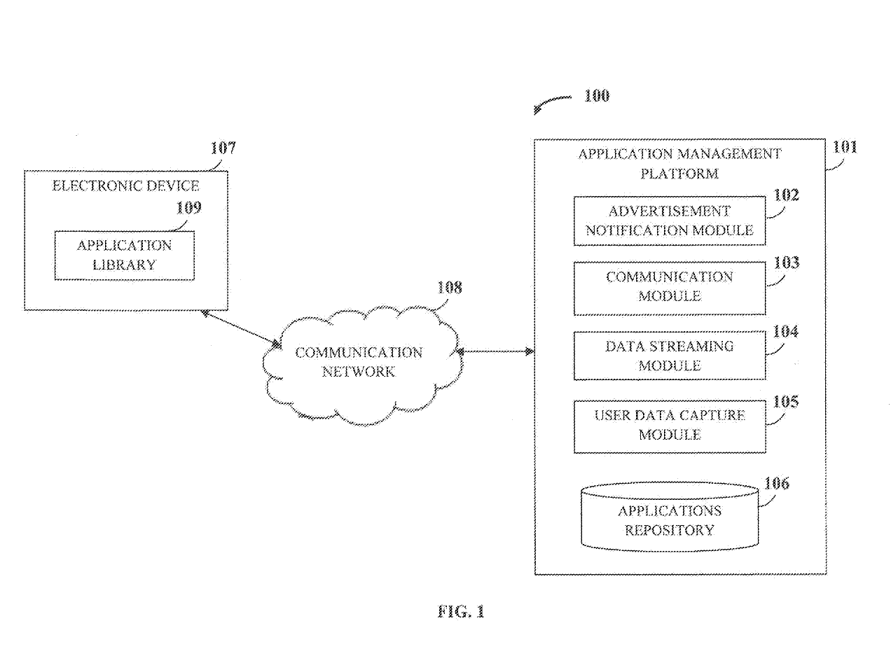

FIG. 1 exemplarily illustrates a system 100 for demonstrating a software application to a user. The term “software application” refers to a computer program that helps the user perform certain activity/activities. The software applications may be, for example, gaming software, utility and productivity tools, a mobile application, etc. As used herein the term “user” refers to an existing customer or a potential customer to whom the software application is delivered, upon a request made by them. As used herein, the term “demonstrating” refers to an act of allowing the user to try a complete version of the software application before buying, downloading or installing the software application on the user's electronic device 107.

The system 100 comprises an application management platform 101 that communicates with an electronic device 107 of the user over a communication network 108. The application management platform 101 hosts the software application. In an embodiment, the application management platform 101 is a customized operating system running on a cloud network. The customized operating system is, for example, an Android operating system 100.

In another embodiment, the application management platform 101 comprises multiple instances of operating systems running on the application management platform 101. In this embodiment, the application management platform 101 allocates one of the instances of the operating systems required to run the software application to the user. The method and system disclosed herein thereby allows virtualization of the operating systems required to run the requested software application. Consider an example where a user tries a software application “X” that requires Android 4.1 operating system (OS). The application management platform 101 then identifies available virtual instances of the Android 4.1 OS and allocates one of those instances of the Android 4.1 OS to the user. The user can then use the software application X by connecting to the application management platform 101.

As used herein, the term “electronic device 107” refers to a personal device of the user such as a mobile phone, a tablet computer, a personal digital assistant (PDA), a laptop, etc. The communication network 108 is, for example, the Internet, an intranet, a local area network, a wide area network, a wireless network, a telecommunication network, etc.

The application management platform 101 comprises an advertisement notification module 102, a communication module 103, a data streaming module 104, a user data capture module 105, and an applications repository 106.

The advertisement notification module 102 provides an advertisement notification to the user via the electronic device 107. As used herein, the term “advertisement notification” refers to a notification that aids in promoting the software application. The advertisement notification is, for example, an icon of the software application, clicking on which allows the user to access the software application hosted on the application management platform 101.

In an embodiment, the advertisement notification module 102 provides the advertisement notification to the user by embedding the software application in a third party application program on the electronic device 107 of the user. The applications repository 106 is a database where the software application may be stored. The applications repository 106 may comprise multiple third party application programs, with an advertisement notification embedded in each of the third party application programs. In this embodiment, the user is presented with the advertisement notification related to the software application when the user is using the third party application program on the electronic device 107, resulting in cross-promotion of the software application via the third party application program. The advertisement notification is, for example, a virtual button such as “Try Now”, “Call to Action”, “Try an App”, “Try before Install”, “Get Hands on App”, etc., embedded in the third party application program.

In another embodiment, the advertisement notification module 102 provides the advertisement notification to the user through a third party webpage. In this embodiment, the user is presented with the advertisement notification relating to the software application on the user's electronic device 107 while browsing through a third party webpage.

A connection is established between the electronic device 107 and the application management platform 101 over the communication network 108, on performing an action on the advertisement notification by the user. As used herein, the term “action” is, for example, a click on the advertisement notification. The data streaming module 104 of the application management platform 101 streams the audiovisual content of the software application to the user's electronic device 107. When the user clicks on the advertisement notification, the data streaming module 104 initiates streaming of the software application to the user's electronic device 107.

The user data capture module 105 captures user inputs from the electronic device 107. The user inputs comprise, for example, motions performed by the user on the streamed audiovisual content. The user inputs are, for example, mouse-clicks, sensory inputs, and other motions performed by the user on the streamed software application. The user inputs captured by the user data capture module 105 enables the application management platform 101 to continuously stream the audiovisual content to the user's electronic device 107. For example, when the software application is gaming software, the captured user inputs comprise the response of the user to the game that is streamed from the application management platform 101. The user inputs may, for example, allow the user to proceed to the next stage or level in the game, and enable the user to participate in the entire game. The system 100 disclosed herein thereby allows the user to try a full version of the software application without the user having to install the software application on the electronic device 107.

In an embodiment, the electronic device 107 of the user further comprises an application library 109 installed on the electronic device 107 that manages communication between the electronic device 107 and the application management platform 101, on the performing of the action on the advertisement notification by the user. In this embodiment, the advertisement notification of the software application is embedded in a third party application program on the user's electronic device 107. The advertisement notification is, for example, a “call to action” tab. In an embodiment, the application library 109 launches a user interface via the electronic device 107, on performing the action by the user. That is, when the user performs an action on the advertisement notification, for example, by clicking the “call to action” tab the application library 109 launches the user interface.

Moreover, the application library 109 manages communication between the electronic device 107 and the application management platform 101 when the user performs the action on the advertisement notification. That is, the application management platform 101 connects to a virtual instance of Android OS that runs the software application. The application library 109 starts sending the user inputs such as touch and sensory information from the electronic device 107 to the application management platform 101. Further, the application library 109 receives the audiovisual content from the application management platform 101 and displays the audiovisual content to the user through the user interface. In an embodiment, the application library 109 comprises an “Install” button, clicking on which directs the user to an application store comprising the software application or starts a download of the software application to the electronic device 107.

In an embodiment, an application webpage manages communication between the electronic device 107 and the application management platform 101, on the performing of the action on the advertisement notification by the user. In this embodiment, when the user performs an action on the advertisement notification, for example, by clicking the “call to action” tab, the application webpage is launched via a browser of the electronic device 107. The browser may be, for example, a desktop browser, a mobile browser, etc. Moreover, the application webpage may be, for example, a desktop application webpage, a mobile application webpage, etc. When the user performs the action through a mobile browser, the mobile application webpage is launched. When the user performs the action through a desktop browser, the desktop application webpage is launched. For accessing the software application from a desktop web browser instead of a mobile web browser, an emulated sensor is provided on the desktop application webpage that sends the information to the application management platform 101. Emulated sensors comprise sensors, for example, global positioning system (GPS), accelerometer, rotation, audio output, etc.

In an embodiment, the application webpage is launched via a browser of the electronic device when the user performs the action on the advertisement notification embedded in a third party application program. In another embodiment, the application webpage is launched via the browser of the electronic device when the user performs the action on the advertisement notification on the third party webpage.

The application webpage then connects to a virtual instance of the Android OS on the application management platform 101. The application webpage starts sending the user inputs such as touch and sensory information from the electronic device to the application management platform 101. Further, the application webpage receives the audiovisual content from the application management platform 101 and displays the audiovisual content to the user. The application webpage thereby manages communication between the electronic device 107 and the application management platform 101. In an embodiment, the application webpage comprises an “Install” button, clicking on which directs the user to an application store comprising the software application or starts a download of the software application to the electronic device 107.

Consider an example where the user clicks on an advertisement notification embedded in a third party application program, where the third party application program is installed on the user's electronic device 107. The advertisement notification is, for example, a virtual button labeled “Try Now” embedded in the third party application program. On clicking the virtual button, the software application pertaining to the advertisement notification is launched on the user's electronic device 107 directly from the application management platform 101. The software application is, for example, a game software. Further, the application management platform 101 streams the game software to the user's electronic device 107. The user may play the game, for example, by pressing appropriate keys on the user's electronic device 107. The actions performed by the user on the game software application are captured by the application management platform 101 in the form of user inputs. The application management platform 101 iteratively captures the user inputs and streams the game software to the user's electronic device 107, until a full version of the game is demonstrated to the user.

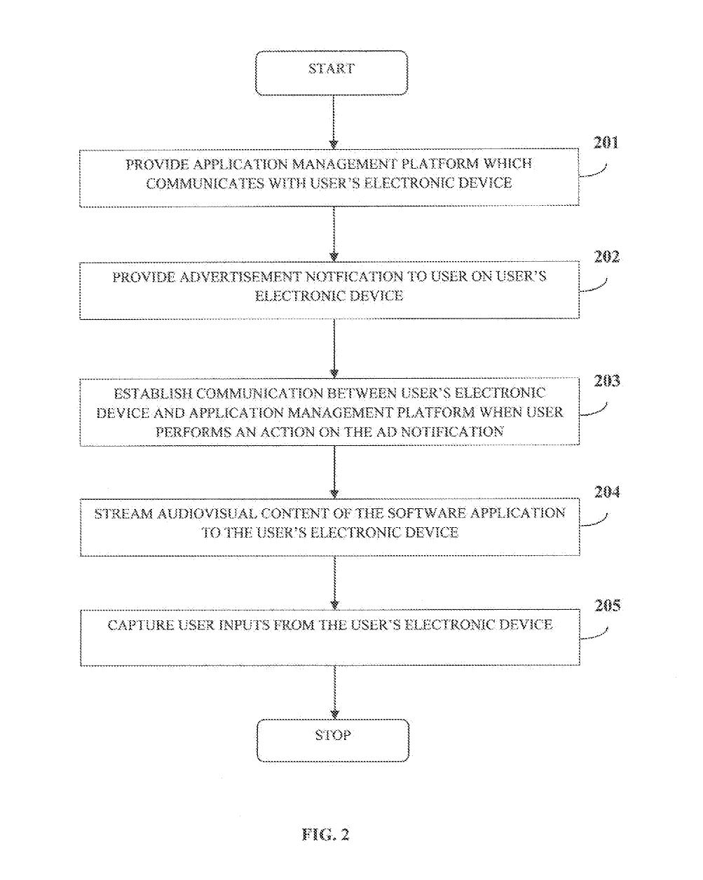

FIG. 2 illustrates a method for demonstrating a software application to a user. An application management platform 101 is provided 201. The application management platform 101 communicates with the electronic device 107 of a user over the communication network 108. The application management platform 101 provides 202 an advertisement notification to the user via the electronic device 107. In an embodiment, the application management platform 101 provides the advertisement notification to the user by embedding the software application in a third party application program on the user's electronic device 107. In another embodiment, the application management platform 101 provides the advertisement notification to the user through a web site.

A connection is established 203 between the user's electronic device 107 and the application management platform 101 on performing an action on the advertisement notification by the user. The application management platform 101 streams 204 audiovisual content of the software application to the user's electronic device 107. The application management platform 101 captures 205 the user's inputs from the electronic device 107. The user inputs comprise motions performed by the user on the streamed audiovisual content. The application management platform 101 thereby provides the demonstration of a full version of the software application to the user.

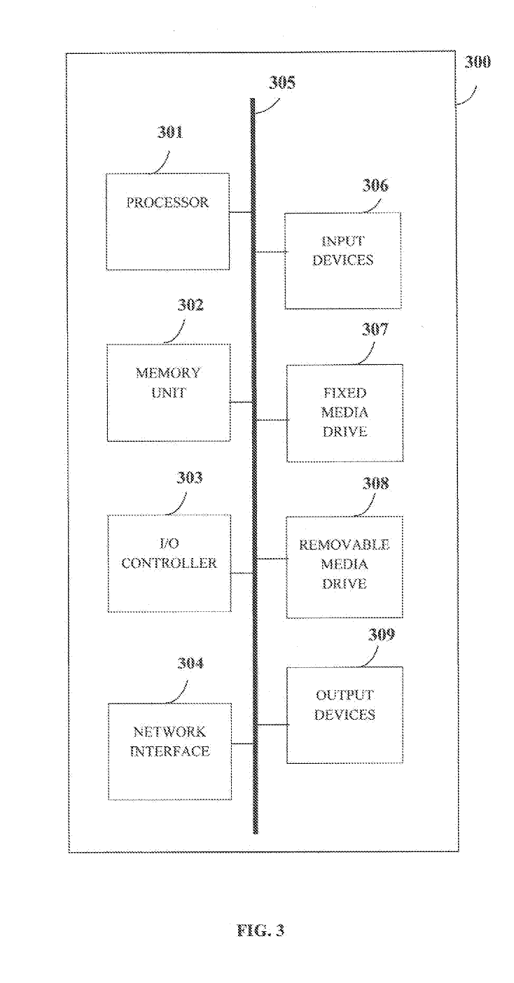

FIG. 3 exemplarily illustrates the architecture of a computer system 300 employed by the application management platform 101 for demonstrating a software application to a user. The computer system 300 comprises, for example, a processor 301, a memory unit 302 for storing programs and data, an input/output (I/O) controller 303, a network interface 304, a data bus 305, input devices 306, output devices 309, etc.

The processor 301 is an electronic circuit that executes computer programs. The memory unit 302 stores programs, applications, and data. For example, the modules 101, 102, 103, 104, 105, and 106 of the application management platform 101 are stored on the memory unit 302 of the computer system 300. The memory unit 302 is, for example, a random access memory (RAM) or another type of dynamic storage device that stores information and instructions for execution by the processor 301. The memory unit 302 also stores temporary variables and other intermediate information used during execution of the instructions by the processor 301. The computer system 300 may further comprise a read only memory (ROM) or another type of static storage device that stores static information and instructions for the processor 301. The network interface 304 enables connection of the computer system 300 to the network. The network interface 304 comprises, for example, an infrared (IR) interface, a WiFi interface, a universal serial bus interface (USB), a local area network (LAN), a wide area network (WAN) interface, etc. The I/O controller 303 controls the input and output actions performed, for example, by administrators of the application management platform 101. The data bus 305 permits communication between the modules, for example, 101, 102, 103, 104, 105, 106, etc., of the application management platform 101.

The input devices 306 are used for inputting data into the computer system 300. The input devices 306 are, for example, a keyboard such as an alphanumeric keyboard, a joystick, a mouse, a touch pad, a light pen, etc. The output devices 309 output the results of the actions computed by the application management platform 101, for example, to administrators of the application management platform 101.

The computer system 300 may comprise, for example, a fixed media drive 307 and a removable media drive 308 for receiving removable media. Computer applications and programs are used for operating the computer system 300. The programs may be loaded onto the fixed media drive 307 and into the memory unit 302 of the computer system 300 via the removable media drive 308. In an embodiment, the computer applications and programs may be loaded directly via the communication network 108.

The processor 301 retrieves the instructions for executing the modules, for example, 101, 102, 103, 104, 105, 106, etc., of the application management platform 101 from the program memory in the form of signals. A program counter determines the location of the instructions in the program memory. The program counter stores a number that identifies the current position in the program of the modules, for example, 101, 102, 103, 104, 105, 106, etc., of the application management platform 101.

The instructions fetched by the processor 301 from the program memory after being processed are decoded. The instructions are placed in an instruction register in the processor 301. After processing and decoding, the processor 301 executes the instructions. For example, the advertisement notification module 102 defines instructions for providing the advertisement notification of the software application to the user via the user's electronic device 107. The communication module 103 defines instructions for establishing a connection with the user's electronic device 107 over the communication network 108. The data streaming module 104 defines instructions for streaming the software application to the user's electronic device 107. The data capture module defines instructions for capturing the user inputs from the user's electronic device 107.

The processor 301 of the application management platform 101 retrieves the instructions defined by the advertisement notification module 102, the communication module 103, the data streaming module 104, and the data capture module and executes the instructions to obtain one or more outputs.

For purposes of illustration, the detailed description refers to the application management platform 101 being run locally on a computer system 300; however the scope of the computer implemented method and system 100 disclosed herein is not limited to the application management platform 101 being run locally on the computer system 300 via the processor 301, but may be extended to run remotely over the communication network 108 by employing a web browser and a remote server, a mobile device, or other electronic devices.

The system 100 disclosed herein offers the users an opportunity to experience the entire version of the software application without downloading or installing the software application. While the description provided herein elaborates on the application management platform 101 running one customized operating system, the same description may be used to illustrate an embodiment wherein the application management platform 101 runs multiple customized operating systems which allows multiple users to simultaneously connect to the application management platform 101 to try out software applications.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer implemented method for demonstrating a software application to a user, comprising:
providing an application management platform that communicates with an electronic device of said user over a communication network;
providing an advertisement notification to said user via said electronic device by said application management platform;
establishing a connection between said electronic device and said application management platform on performing an action on said advertisement notification by said user;
streaming audiovisual content of said software application to said electronic device by said application management platform; and
capturing user inputs from said electronic device by said application management platform, wherein said user inputs comprise motions performed by said user on said streamed audiovisual content;
whereby said application management platform provides said demonstration of a full version of said software application to said user.

2. The computer implemented method of claim 1, wherein said application management platform provides said advertisement notification to said user by embedding said software application in a third party application program on said electronic device of said user.

3. The computer implemented method of claim 1, wherein said application management platform provides said advertisement notification to said user through a third party webpage.

4. The computer implemented method of claim 1, wherein said performing of said action on said advertisement notification comprises clicking said advertisement notification by said user.

5. The computer implemented method of claim 1, further comprising managing communication between said electronic device and said application management platform by an application library installed on said electronic device of said user, on said performing of said action on said advertisement notification by said user.

6. The computer implemented method of claim 5, wherein said communication of said application library with said application management platform comprises receiving said streamed audiovisual content of said software application and transmitting said captured user inputs from said electronic device to said application management platform.

7. The computer implemented method of claim 5, further comprising launching a user interface by said application library via said electronic device on said performing of said action on said advertisement notification by said user.

8. The computer implemented method of claim 1, further comprising managing communication between said electronic device and said application management platform by an application webpage, on said performing of said action on said advertisement notification by said user.

9. The computer implemented method of claim 8, wherein said communication of said application webpage with said application management platform comprises receiving said streamed audiovisual content of said software application and transmitting said captured user inputs from said electronic device to said application management platform.

10. A computer implemented system for demonstrating a software application to a user, comprising:
an application management platform that communicates with an electronic device of said user over a communication network, wherein said application management platform comprises:
an advertisement notification module that provides an advertisement notification to said user via said electronic device;
a communication module that establishes a connection between said electronic device and said application management platform on performing an action on said advertisement notification by said user;
a data streaming module that streams audiovisual content of said software application from said application management platform to said electronic device; and
a user data capture module that captures user inputs from said electronic device, wherein said user inputs comprise motions performed by said user on said streamed audiovisual content.

11. The computer implemented system of claim 10, wherein said advertisement notification module provides said advertisement notification to said user by embedding said software application in a third party application program on said electronic device of said user.

12. The computer implemented system of claim 10, wherein said advertisement notification module provides said advertisement notification to said user through a third party webpage.

13. The computer implemented system of claim 10, further comprising an application library installed on said electronic device of said user that manages communication between said electronic device and said application management platform, on said performing of said action on said advertisement notification by said user.

14. The computer implemented system of claim 13, further comprising a user interface launched via said electronic device by said application library on said performing of said action on said advertisement notification by said user.

15. The computer implemented system of claim 10, further comprising an application webpage that manages communication between said electronic device and said application management platform, on said performing of said action on said advertisement notification by said user.
